(19) United States
(12) Patent Application Publication
(10) Pub. No.: US 2026/0312144 A1
(43) Pub. Date: Oct. 8, 2026

(54) CYLINDRICAL SECONDARY BATTERY

(71) Applicant: Panasonic Intellectual Property Management Co., Ltd., Kadoma-shi, Osaka (JP)

(72) Inventors: Marina Muranishi, Osaka (JP); Tasuku Ishiguro, Osaka (JP); Kota Ogawa, Tokushima (JP); Norihisa Yamamoto, Osaka (JP)

(73) Assignee: Panasonic Intellectual Property Management Co., Ltd., Kadoma-shi, Osaka (JP)

(21) Appl. No.: 19/477,966

(22) PCT Filed: Apr. 9, 2024
(86) PCT No.: PCT/JP2024/014368

§ 371 Date: Oct. 23, 2025

(30) Foreign Application Priority Data
Apr. 28, 2023 (JP) 2023-074088

(51) Int. Cl. H01M 10/0587; H01M 4/02; H01M 50/107; H01M 50/533

(52) U.S. Cl. CPC H01M 10/0587; H01M 50/107; H01M 50/533; H01M 2004/021; H01M 2004/028

(57) ABSTRACT

A protective member covers the positive electrode exposed part, the tab, and a portion, of the positive electrode mixture layer, adjacent to the positive electrode exposed part. When the positive electrode mixture layer is divided into a first positive electrode mixture layer aligned with the positive electrode exposed part in the longitudinal direction of the positive electrode, and a second positive electrode mixture layer adjacent to the positive electrode exposed part and the first positive electrode mixture layer in the width direction of the positive electrode, the tacking strength T1 of the first positive electrode mixture layer and the tacking strength T2 of the second positive electrode mixture layer satisfy the relationship T1>T2.

### TECHNICAL FIELD

The present disclosure relates to a cylindrical secondary battery.

### BACKGROUND ART

A cylindrical secondary battery is a battery with an electrode assembly in which a positive electrode and a negative electrode are wound via a separator, the electrode assembly being housed in a cylindrical exterior housing can. Each of the positive electrode and the negative electrode has a current collector and a mixture layer disposed on a surface of the current collector, and the mixture layer includes an active material capable of reversibly occluding and releasing Li ions. An exposed portion where the current collector is exposed is formed on a surface of the electrode, and a tab for connecting the electrode to a battery terminal is connected to the exposed portion. Patent Literature 1 discloses a technique of forming a plurality of exposed portions on an electrode to connect a tab to each of the exposed portions for the purpose of suppressing heat generation at a tab connected portion and improving current collecting efficiency. On the electrode disclosed in Patent Literature 1, the exposed portions are formed over the entire length in a width direction. Further, in general, a known technique is to cover an exposed portion and a periphery thereof with a protective member such as an insulating tape to ensure the safety of a battery even when a separator is damaged.

### CITATION LIST

### Patent Literature

PATENT LITERATURE 1: Japanese Unexamined Patent Application Publication No. Hei 10-261439

### SUMMARY

In recent years, batteries have been required to have higher capacity. From the viewpoint of an increase in capacity, a smaller area of the exposed portion without a mixture layer formed thereon is preferable. The present inventors have formed the positive electrode exposed portion only in the vicinity of a portion to which a tab is connected, without forming the positive electrode exposed portion over the entire length in the width direction on a positive electrode. The present inventors have further made diligent studies and found that the positive electrode mixture layer may be peeled off from a side parallel to the width direction of the protective member due to repeated charge and discharge. Since the technique disclosed in Patent Literature 1 is not designed for a case where the positive electrode exposed portion is formed only at one end, peeling of the positive electrode mixture layer after a charge-discharge cycle has not been investigated, and there is still room for improvement.

It is an advantage of the present disclosure to provide a cylindrical secondary battery that has a high capacity and prevents a positive electrode mixture layer from peeling off due to repeated charge and discharge.

A cylindrical secondary battery of an aspect of the present disclosure comprises: an electrode assembly in which a positive electrode and a negative electrode are wound via a separator; a non-aqueous electrolyte; and a cylindrical exterior housing can housing the electrode assembly and the non-aqueous electrolyte, wherein the positive electrode has a positive electrode current collector and a positive electrode mixture layer disposed on a surface of the positive electrode current collector; a positive electrode exposed portion where the positive electrode current collector is exposed is disposed on a surface of the positive electrode; the positive electrode exposed portion is in contact with only one end of opposite ends of the positive electrode in a width direction; a positive electrode tab is connected to the positive electrode exposed portion and drawn out from one end thereof; a protective member covers the positive electrode exposed portion, the positive electrode tab, and a portion of the positive electrode mixture layer adjacent to the positive electrode exposed portion; and when the positive electrode mixture layer is divided into a first positive electrode mixture layer aligned with the positive electrode exposed portion in a longitudinal direction of the positive electrode and a second positive electrode mixture layer adjacent to the positive electrode exposed portion and the first positive electrode mixture layer in a width direction of the positive electrode, a tack strength T1 of the first positive electrode mixture layer and a tack strength T2 of the second positive electrode mixture layer satisfy a relationship of T1>T2.

According to the cylindrical secondary battery of the present disclosure, a positive electrode mixture layer may be prevented from peeling off after a charge-discharge cycle.

### BRIEF DESCRIPTION OF DRAWING

FIG. 1 is a longitudinal sectional view of a cylindrical secondary battery of an example of an embodiment.

FIG. 2 is a front view illustrating a positive electrode and a negative electrode that constitute an electrode assembly comprised in the cylindrical secondary battery of FIG. 1 in a developed state.

### DESCRIPTION OF EMBODIMENTS

From the viewpoint of an increase in capacity, an area of a positive electrode exposed portion for connecting the positive electrode tabs is preferably as small as possible. Therefore, a possible aspect is to form the positive electrode exposed portion only in the vicinity of a portion to which a positive electrode tab is connected, without forming the positive electrode exposed portion over the entire length of the positive electrode in the width direction. Furthermore, the positive electrode exposed portion and the periphery thereof are covered with a protective member such as insulating tape, from the viewpoint of improving battery reliability. However, it has been revealed that when a positive electrode having such an aspect is used, the positive electrode mixture layer is likely to be peeled off from a side parallel to the width direction of the protective member due to charge-discharge cycles. It is considered that when the electrode assembly expands and contracts in the longitudinal direction due to charge and discharge, stress is concentrated on a part of the side parallel to the width direction of the protective member, and the positive electrode mixture layer is peeled off. As a result of intensive studies, the present inventors have found that the peeling of the positive electrode mixture layer and the reduction in the battery capacity can be suppressed when the tack strength T1 of the first positive electrode mixture layer aligned with the positive electrode exposed portion in the longitudinal direction of the positive electrode is larger than the tack strength 12 of the second positive electrode mixture layer adjacent to the positive electrode exposed portion and the first positive electrode mixture layer in the width direction of the positive electrode.

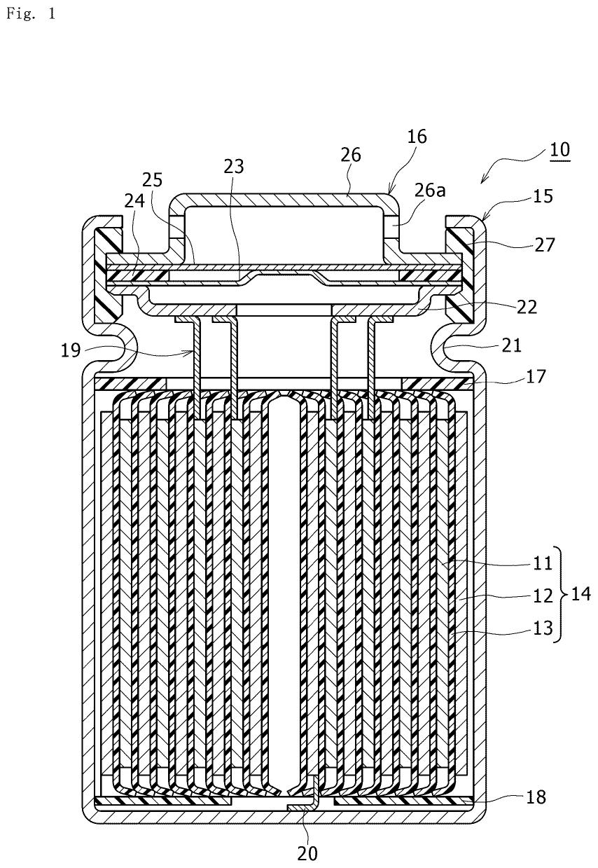

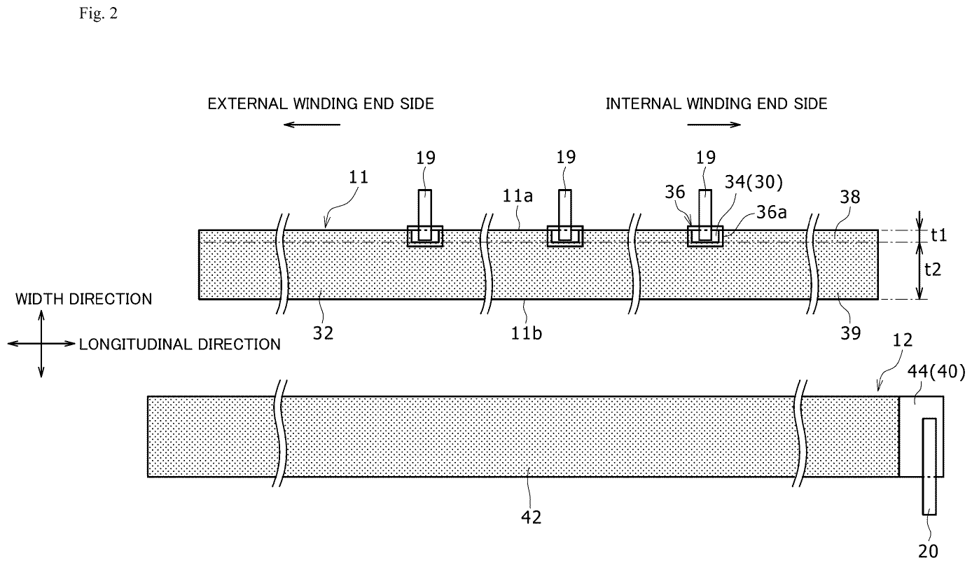

Hereinafter, an example of an embodiment of a cylindrical secondary battery according to the present disclosure will be described in detail with reference to FIGS. 1 and 2. In the following description, specific shapes, materials, values, directions, and the like, which are examples for facilitating understanding of the present invention, may be appropriately modified with specifications of cylindrical secondary batteries. In the following description, when a plurality of embodiments and modifications are included, it is assumed from the beginning that characteristics portions thereof are used in combination as appropriate. As used herein, the term “substantially” is used in the same meaning as the term “approximately”, and the requirement “substantially . . . ” is satisfied if being practically the same.

FIG. 1 is a longitudinal sectional view of a cylindrical secondary battery 10 (hereinafter, referred to as the secondary battery 10) of an example of an embodiment. In the secondary battery 10 illustrated in FIG. 1, an electrode assembly 14 and a non-aqueous electrolyte (not illustrated) are housed in an exterior housing can 15. For convenience of description, a sealing assembly 16 side will be described as the “upper side”, and the bottom side of the exterior housing can 15 will be described as the “lower side”.

The electrode assembly 14 has a wound structure in which a positive electrode 11 and a negative electrode 12 are wound via a separator 13. Each of the positive electrode 11, the negative electrode 12, and the separator 13 is an elongated band-shaped body, which is spirally wound to be alternately stacked in a radial direction of the electrode assembly 14. The separator 13 is formed to be one size larger than the positive electrode 11 and the negative electrode 12, and two of the separator 13 are disposed to sandwich the positive electrode 11.

For the separator 13, a porous sheet having an ion permeation property and an insulation property, or the like is used, for example. Specific examples of the porous sheet include a microporous thin film, a woven fabric, and a nonwoven fabric. Preferred materials for the separator include olefin-based resins such as polyethylene and polypropylene, and cellulose. The separator 13 may be a laminate having a cellulose fiber layer and a thermoplastic resin fiber layer such as an olefin-based resin. Alternatively, the separator 13 may be a multilayer separator including a polyethylene layer and a polypropylene layer, and a separator 13 having a surface coated with materials such as aramid resin or ceramics may be used.

The non-aqueous electrolyte has lithium ion conductivity. The non-aqueous electrolyte may be a liquid electrolyte (electrolyte solution) or a solid electrolyte.

The liquid electrolyte (electrolyte solution) includes a non-aqueous solvent and an electrolyte salt dissolved in the non-aqueous solvent. As the non-aqueous solvent, for example, esters, ethers, nitriles, amides, and mixed solvents composed of two or more of these solvents may be used. Examples of the non-aqueous solvent include ethylene carbonate (EC), ethyl methyl carbonate (EMC), dimethyl carbonate (DMC), diethyl carbonate (DEC), and mixed solvents thereof. The non-aqueous solvent may also contain a halogen-substituted product (e.g., fluoroethylene carbonate) in which at least a portion of the hydrogen atoms in these solvents are replaced with halogen atoms such as fluorine. As the electrolyte salt, for example, a lithium salt such as LiPF₆ is used.

As the solid electrolyte, for example, a solid or gel-type polymer electrolyte or an inorganic solid electrolyte may be used. As the inorganic solid electrolyte, materials known for use in all-solid lithium-ion secondary batteries (oxide-based solid electrolytes, sulfide-based solid electrolytes, halogen-based solid electrolytes, etc.) may be used. The polymer electrolyte includes, for example, a lithium salt and a matrix polymer, or a non-aqueous solvent, a lithium salt, and a matrix polymer. As the matrix polymer, for example, polymer materials capable of absorbing the non-aqueous solvent and forming a gel may be used. Examples of the polymer materials include fluororesins, acrylic resins, and polyether resins.

The sealing assembly 16 seals an opening of an upper end of the exterior housing can 15 to seal an inside of the secondary battery 10. Insulating plates 17 and 18 are provided on the upper and lower sides of the electrode assembly 14, respectively. A positive electrode tab 19 extends through a through hole of the insulating plate 17 toward the upper and lower sides and connects a filter 22, a bottom plate of the sealing assembly 16, to the positive electrode 11 included in the electrode assembly 14. As a result, the positive electrode 11 and the sealing assembly 16 are connected, and in the secondary battery 10, a cap 26, a top plate of the sealing assembly 16 electrically connected to the filter 22, becomes a positive electrode terminal. The positive electrode tab 19 is, for example, an aluminum tab. Meanwhile, a negative electrode tab 20 extends through a through hole of the insulating plate 18 toward the bottom side of the exterior housing can 15, and the negative electrode tab 20 is welded to a bottom inner surface of the exterior housing can 15. As a result, the negative electrode 12 and the exterior housing can 15 are connected, and in the secondary battery 10, the exterior housing can 15 becomes a negative electrode terminal. The negative electrode tab 20 is, for example, an nickel tab.

In an example illustrated in FIG. 1, four positive electrode tabs 19 are drawn out from the electrode assembly 14 and welded in the sectional view. The number of positive electrode tabs 19 to be drawn out from the electrode assembly 14 is not particularly limited. The use of a plurality of positive electrode tabs 19 improves current collecting efficiency of the positive electrode 11, and thus in turn can improve the output characteristics of the secondary battery 10. The greater the number of positive electrode tabs 19, the better the current collecting efficiency of the positive electrode 11, while the cost of the secondary battery 10 increases. From the viewpoint of achieving both the above effects and cost, the number of positive electrode tabs 19 is preferably greater than or equal to 1 and less than or equal to 20, more preferably greater than or equal to 1 and less than or equal to 10, and particularly preferably greater than or equal to 3 and less than or equal to 8. Note that the three or more positive electrode tabs 19 drawn out from the electrode assembly 14 may be directly connected to the sealing assembly 16, or may be connected to the sealing assembly 16 via a known current collecting member.

As illustrated in FIG. 1, for example, the negative electrode tab 20 is drawn out from the vicinity of the internal winding end of the negative electrode 12 and connected to the exterior housing can 15. The arrangement position of the negative electrode tab 20 is not limited to the example illustrated in FIG. 1, and the negative electrode tab 20 may be provided only in the vicinity of the external winding end of the negative electrode 12 or may be provided both in the vicinity of the internal winding end and the external winding end of the negative electrode 12. Alternatively, a negative electrode exposed portion 44 may be formed at the external winding end of the negative electrode 12, and this negative electrode exposed portion 44 may be in contact with an inner surface of the exterior housing can 15 to electrically connect the vicinity of the external winding end of the negative electrode 12 to the exterior housing can 15 without the use of the negative electrode tab 20.

The exterior housing can 15 is a bottomed cylindrical metallic container having an opening on one side in an axial direction. A gasket 27 is provided between the exterior housing can 15 and the sealing assembly 16 to achieve sealability inside the secondary battery 10. The exterior housing can 15 has a grooved portion 21 that supports the sealing assembly 16, which is formed, for example, by pressing side surface portions from the outside. The grooved portion 21 is preferably formed in a circular shape along a circumferential direction of the exterior housing can 15, and the upper surface of the grooved portion 21 supports the sealing assembly 16.

The sealing assembly 16 has a filter 22, a lower vent member 23, an insulating member 24, an upper vent member 25, and the cap 26, which are stacked in this order from the electrode assembly 14 side. Each member constituting the sealing assembly 16 has, for example, a disk shape or a ring shape, and each member except for the insulating member 24 is electrically connected to each other. The lower vent member 23 and the upper vent member 25 are connected to each other at respective central parts thereof, and the insulating member 24 is interposed between the respective circumferential parts thereof. If the internal pressure of the battery increases due to abnormal heat generation, for example, the lower vent member 23 breaks, and the upper vent member 25 consequently bulges toward the cap 26 and separates from the lower vent member 23, thereby cutting off the electrical connection between the two members. If the internal pressure further increases, the upper vent member 25 breaks, and gas is discharged through the opening portion 26a of the cap 26.

Next, the positive electrode 11 and the negative electrode 12 will be described with reference to FIG. 2. FIG. 2 is a front view illustrating the positive electrode 11 and the negative electrode 12 that constitute the electrode assembly 14 comprised in the secondary battery 10 of FIG. 1 in a developed state. As illustrated in FIG. 2, in general, the negative electrode 12 is formed to be one size larger than the positive electrode 11 to prevent precipitation of lithium. That is, the negative electrode 12 is formed to be longer than the positive electrode 11 in a longitudinal direction and a width direction.

The positive electrode 11 has a positive electrode current collector 30 and a positive electrode mixture layer 32 disposed on a surface of the positive electrode current collector 30. A positive electrode exposed portions 34, in which the positive electrode current collector 30 is exposed, are disposed on the surface of the positive electrode 11, and the positive electrode exposed portions 34 are in contact with only one end 11a of opposite ends of the positive electrode 11 in the width direction. In other words, the positive electrode exposed portions 34 do not extend to the other end 11b of the positive electrode 11 in the width direction. As a result, the positive electrode mixture layer 32 is present between the positive electrode exposed portions 34, thus increasing the area of the positive electrode mixture layer 32 and improving the battery capacity of the secondary battery 10.

A plurality of positive electrode exposed portions 34 are preferably disposed on the surface of the positive electrode 11. Each of the positive electrode exposed portions 34 is connected to one of the positive electrode tabs 19, thus improving the current collecting efficiency of the positive electrode 11 as well as the output characteristics of the secondary battery 10. In addition, the effect of the technique disclosed in the present application described later becomes more remarkable as the number of the positive electrode exposed portions 34 is larger. The number of the positive electrode exposed portions 34 is preferably greater than or equal to 1 and less than or equal to 20, more preferably greater than or equal to 1 and less than or equal to 10, and particularly preferably greater than or equal to 3 and less than or equal to 8.

The positive electrode exposed portion 34, the positive electrode tab 19, and the portion of the positive electrode mixture layer 32 adjacent to the positive electrode exposed portion 34 are covered with the protective member 36. In other words, the protective member 36 covers the positive electrode tab 19, the positive electrode exposed portion 34, and a portion of the positive electrode mixture layer 32. The protective member 36 is an insulating member that prevents the positive electrode tab 19 and the positive electrode exposed portion 34 from internally short-circuiting with the opposing negative electrode mixture layer when the separator 13 is damaged.

The protective member 36 is, for example, an adhesive tape having a base material portion and an adhesive portion formed on one surface of the base material portion. A heat-resistant layer including, for example, inorganic particles such as metal oxides can be provided between the base material portion and the adhesive portion. The base material portion may be made of an insulating resin, and, for example, polyphenylene sulfide (PPS), polyether ether ketone (PEEK), polyimide (PI), polypropylene (PP), polyethylene terephthalate (PET), and polybutylene terephthalate (PBT) may be used. The thickness of the base material portion is, for example, greater than or equal to 5 μm and less than or equal to 50 μm.

The adhesive portion is a portion for adhering the protective member 36 to the surface of the positive electrode 11. The thickness of the adhesive portion is, for example, greater than or equal to 1 μm and less than or equal to 30 μm. The adhesive portion may include at least one of the group consisting of a rubber-based polymer and an acrylic-based polymer. Since the rubber-based polymer and the acrylic-based polymer have adhesiveness, the protective member 36 can be adhered to the surface of the positive electrode 11. For example, a silicone-based polymer may be further added to the adhesive portion.

For the positive electrode current collector 30, a foil of a metal stable within a potential range of the positive electrode, such as aluminum, a film in which such a metal is disposed on a surface layer thereof, and the like may be used. The thickness of the positive electrode current collector 30 is, for example, greater than or equal to 10 μm and less than or equal to 30 μm.

The positive electrode mixture layer 32 is preferably formed on both surfaces of the positive electrode current collector 30. The thickness of the positive electrode mixture layer 32 is, for example, greater than or equal to 10 μm and less than or equal to 150 μm on one side of the positive electrode current collector 30. The positive electrode mixture layer 32 includes, for example, a positive electrode active material, a conductive agent, and a binder. The positive electrode can be produced by, for example, applying a positive electrode mixture slurry including the positive electrode active material, the conductive agent, the binder, and the like on both the surfaces of the positive electrode current collector 30, drying the coating film, and then rolling the coating film by using a roller or the like.

Examples of the positive electrode active material included in the positive electrode mixture layer 32 include a lithium-transition metal composite oxide containing a transition metal element, such as Co, Mn, or Ni. The lithium-transition metal composite oxide is, for example, LiₓCoO₂, LiₓNiO₂, LiₓMnO₂, LiₓCo_{y}Ni_{1-y}O₂, LiₓCo_{y}M_{1-y}O_{z}, LiₓLNi_{1-y}M_{y}O_{z}, LiₓMn₂O₄, LiₓMn_{2-y}MyO₄, LiMPO₄, or Li₂MPO₄F (M is at least one of the group consisting of Na, Mg, Sc, Y, Mn, Fe, Co, Ni, Cu, Zn, Al, Cr, Pb, Sb, and B, where 0<x≤1.2, 0<y≤0.9, 2.0≤z≤2.3). These may be used alone, or a plurality of types thereof may be mixed for use.

The positive electrode active material preferably includes lithium-nickel composite oxide in terms of its ability to increase the capacity of the secondary battery 10. Examples of the lithium-nickel composite oxide include LiₓNiO₂, LiₓCo_{y}Ni_{1-y}O₂, and LiₓNi_{1-y}M_{y}O_{z} (M is at least one of the group consisting of Na. Mg, Sc. Y. Mn. Fe, Co, Ni, Cu. Zn, Al, Cr, Pb, Sb, and B, where 0<x≤1.2, 0<y≤0.9, 2.0≤z≤2.3). The higher the Ni content in the lithium-nickel composite oxide, the higher the capacity.

Examples of the conductive agent included in the positive electrode mixture layer 32 include carbon-based particles such as carbon black (CB), acetylene black (AB), Ketjenblack, carbon nanotube (CNT), graphene, and graphite. These may be used alone or may be used in combination with two or more thereof.

Examples of the binder included in the positive electrode mixture layer 32 include a fluororesin such as polytetrafluoroethylene (PTFE) and polyvinylidene fluoride (PVDF), polyacrylonitrile (PAN), a polyimide resin, an acrylic resin, and a polyolefin resin. These may be used alone or may be used in combination with two or more thereof.

The positive electrode mixture layer 32 can be divided into a first positive electrode mixture layer 38 aligned with the positive electrode exposed portion 34 in the longitudinal direction of the positive electrode 11 and a second positive electrode mixture layer 39 adjacent to the positive electrode exposed portion 34 and the first positive electrode mixture layer 38 in the width direction of the positive electrode 11. The length t1 of the first positive electrode mixture layer 38 in the width direction and the length t2 of the second positive electrode mixture layer 39 in the width direction preferably satisfy a relationship of 1/10≤t1/t2≤1, and more preferably a relationship of ⅛≤t1/t2≤½.

The tack strength T1 of the first positive electrode mixture layer 38 and the tack strength T2 of the second positive electrode mixture layer 39 satisfy the relationship of T1>T2. Accordingly, the peeling of the positive electrode mixture layer 32 and the reduction in the battery capacity can be suppressed. The first positive electrode mixture layer 38 preferably has a relatively high tack strength because the positive electrode mixture layer 38 is likely to be peeled off from a side 36a parallel to the width direction of the protective member 36 due to charge-discharge cycles. On the other hand, the second positive electrode mixture layer 39 preferably has a lower tack strength than the first positive electrode mixture layer 38 from the viewpoint of improving the battery capacity because the second positive electrode mixture layer 39 is less likely to be peeled off than the first positive electrode mixture layer 38.

The T1 and the T2 preferably satisfy a relationship of 1.03≤T1/T2≤1.68, and more preferably a relationship of 1.10≤T1/T2≤1.42. The T1 is preferably greater than or equal to 320 N and less than or equal to 520 N, and more preferably greater than or equal to 340 N and less than or equal to 440 N. The T2 is, for example, greater than or equal to 250 N and less than or equal to 400 N.

The tack strength of the first positive electrode mixture layer 38 and the second positive electrode mixture layer 39 can be measured by using a commercially available tacking tester (e.g., TAC-II manufactured by RHESCA CO., LTD.). Specific measurement conditions are as follows.

### [Test Sample]

The first positive electrode mixture layer 38 and the second positive electrode mixture layer 39 are each cut from the positive electrode 11 to a predetermined size and used as test samples. When the positive electrode 11 is incorporated into a battery, the battery is disassembled to extract the positive electrode 11, which is then dried in a vacuum for 1 hour and cut to prepare test samples.

### [Measurement Condition]

Double-sided tape #515 manufactured by Nitto Denko Corporation is attached to the tip of a metallic rod with an adhesive area of 2 mm φ, and a test sample is held under a pre-load of 400 gf for 10 seconds and then peeled off at a speed of 600 mm/min. Stress required for peeling is measured. Five samples of each of the first positive electrode mixture layer 38 and the second positive electrode mixture layer 39 are measured to obtain the average value of the measured values as the tack strength (N).

The tack strength of the positive electrode mixture layer 32 can be adjusted, for example, by subjecting the positive electrode mixture layer 32 to heat treatment. More specifically. T1, T2, and T1/T2 can be adjusted to be in the above-described ranges by subjecting only the first positive electrode mixture layer 38 to the heat treatment, while leaving the second positive electrode mixture layer 39 untreated. Increasing the heat treatment temperature results in an increase in tack strength. In addition, extending the heat treatment time results in an increase in tack strength. The heat treatment temperature may be, for example, greater than or equal to 100° C. and less than or equal to 250° C. The heat treatment time may be, for example, greater than or equal to 3 seconds and less than or equal to 60 seconds.

The heat treatment of the positive electrode mixture layer 32 can be performed, for example, by bringing a high-temperature roller into contact with only the first positive electrode mixture layer 38. For example, the heat treatment temperature and heat treatment time can be adjusted by adjusting the temperature and rotation speed of the roller. Although the tack strength increases as described above by performing heat treatment, the battery capacity may decrease, probably because components contained in the positive electrode mixture layer 32, particularly the binder, form a coating film on the surface of the active material.

The peel strength P1 of the first positive electrode mixture layer and the peel strength P2 of the second positive electrode mixture layer preferably satisfy a relationship of P1>P2. The P1 and the P2 more preferably satisfy a relationship of 1.13≤P1/P2≤1.63, and particularly preferably a relationship of 1.19≤P1/P2≤1.38. The P1 is preferably greater than or equal to 9 N/m and less than or equal to 13 N/m, and more preferably greater than or equal to 9.5 N/m and less than or equal to 11 N/m. The P2 is, for example, greater than or equal to 6 N/m and less than or equal to 10 N/m.

The peel strength of the first positive electrode mixture layer 38 and the second positive electrode mixture layer 39 can be measured, for example, as follows.

### [Test Sample]

The first positive electrode mixture layer 38 and the second positive electrode mixture layer 39 are each cut from the positive electrode 11 to a predetermined size and used as test samples. When the positive electrode 11 is incorporated into a battery, the battery is disassembled to extract the positive electrode 11, which is then dried in a vacuum for 1 hour and cut to prepare test samples.

### [Measurement Condition]

Double-sided tape #515, manufactured by Nitto Denko Corporation, is attached to the positive electrode mixture layer 32 on one surface of the test piece and fixed to a stainless steel base material with a smooth surface. The stainless steel base material, to which the test sample is fixed, is placed in a horizontal orientation. One end of the positive electrode current collector 30 in the longitudinal direction of the test sample is fixed to a movable jig of a tensile testing machine (e.g., TENSILON Universal Tensile Testing Machine RTC1210, manufactured by A & D Co., Ltd.), and the positive electrode current collector 30 is set to be peeled off in a direction of 90° relative to the base material surface of the stainless steel base material. Then, the movable jig is moved to peel off the positive electrode mixture layer 32 and the positive electrode current collector 30 of the test piece at a speed of 20 mm/min. At that time, the tensile direction is always maintained at 90° relative to the base material surface of the stainless steel base material fixing the test piece. The numerical value of the stable tensile strength is read when greater than or equal to 30 mm of the test sample is peeled off. Five samples of each of the first positive electrode mixture layer 38 and the second positive electrode mixture layer 39 are measured to obtain the average value of the measured values as the peel strength (N/m).

The negative electrode 12 has a negative electrode current collector 40 and a negative electrode mixture layer 42 disposed on a surface of the negative electrode current collector 40. The negative electrode 12 has a negative electrode exposed portion 44 where the negative electrode current collector 40 is exposed, for example, at an internal winding end in the longitudinal direction, and the negative electrode tab 20 is connected to the negative electrode exposed portion 44.

For the negative electrode current collector, a foil of a metal stable within a potential range of the negative electrode, such as copper, a film in which such a metal is disposed on a surface layer thereof, and the like may be used. The thickness of the negative electrode current collector is, for example, greater than or equal to 5 μm and less than or equal to 30 μm.

The negative electrode mixture layer is preferably formed on both surfaces of the negative electrode current collector. The thickness of the negative electrode mixture layer is, for example, greater than or equal to 10 μm and less than or equal to 150 μm on one side of the negative electrode current collector. The negative electrode mixture layer includes, for example, a negative electrode active material and a binder. The negative electrode can be produced by, for example, applying a negative electrode mixture slurry including the negative electrode active material, the binder, and the like on both the surfaces of the negative electrode current collector, drying the coating film, and then rolling the coating film by using a roller or the like.

The negative electrode active material included in the negative electrode mixture layer is not particularly limited as long as it can reversibly occlude and release lithium ions, and carbon materials such as graphite are typically used. The graphite may be any of natural graphite such as flake graphite, massive graphite, and amorphous graphite, and artificial graphite such as massive artificial graphite and graphitized mesophase carbon microbead.

As the negative electrode active material, a metal that forms an alloy with Li, such as Si and Sn, a metal compound including Si. Sn. and the like, a lithium-titanium composite oxide, and the like may also be used. For example, a Si-containing compound represented by SiOₓ (0.5≤x≤1.6), a Si-containing compound in which fine particles of Si are dispersed in a lithium silicate phase represented by Li_{2y}SiO_{(2+y)} (0<y<2), or a Si-containing compound in which Si is dispersed in a carbon material may be used in combination with graphite.

Examples of the binder included in the negative electrode mixture layer include styrene-butadiene rubber (SBR), nitrile-butadiene rubber (NBR), carboxymethylcellulose (CMC) or a salt thereof polyacrylic acid (PAA) or a salt thereof (which may be PAA-Na. PAA-K, and the like, or a partially neutralized salt), and polyvinyl alcohol (PVA). These may be used alone or may be used in combination with two or more thereof.

### EXAMPLES

Hereinafter, the present disclosure will be further described with Examples, but the present disclosure is not limited to these Examples.

### Example 1-1

### Production of Positive Electrode

As a positive electrode active material, an aluminum-containing lithium nickel cobaltate represented by LiNi_{0.88}Co_{0.09}Al_{0.03}O₂ was used. First, 100 parts by mass of the positive electrode active material. 1 part by mass of acetylene black (AB), and 1 part by mass of polyvinylidene fluoride (PVDF) were mixed, and an appropriate amount of N-methyl-2-pyrrolidone (NMP) was added to prepare a positive electrode mixture slurry. Next, the positive electrode mixture slurry was applied to both surfaces of a band-shaped positive electrode current collector composed of an aluminum foil having a thickness of 15 μm so that eight positive electrode exposed portions were formed. As in the example illustrated in FIG. 2, the positive electrode exposed portions were in contact with only one end of positive electrode in the width direction. The t1/t2 calculated from the length t1 of the first positive electrode mixture layer in the width direction and the length t2 of the second positive electrode mixture layer in the width direction was ⅕.

After the coating film was dried and rolled, a portion corresponding to the first positive electrode mixture layer was subjected to a heat treatment by being brought into contact with a roller at 180° C. for 10 seconds. Next, the coating film was cut into a predetermined electrode size to produce a positive electrode in which a positive electrode mixture layer was formed on both surfaces of a positive electrode current collector. Thereafter, a positive electrode tab made of aluminum was welded to each of eight positive electrode exposed portions, and an insulating tape was affixed to cover the positive electrode exposed portions, the positive electrode tab, and a part of the positive electrode mixture layer adjacent to the positive electrode mixture layer. The first positive electrode mixture layer had a tack strength T1 of 370 N and a peel strength P1 of 10N/m. The second positive electrode mixture layer had a tack strength T1 of 310 N and a peel strength P1 of 8 N/m.

### Production of Negative Electrode

Mixing 95 parts by mass of graphite, 5 parts by mass of SiO oxide (SiO), 1 part by mass of sodium carboxymethylcellulose (CMC-Na), 1 part by mass of styrene-butadiene rubber (SBR) were performed, and an appropriate amount of water was added to prepare a negative electrode mixture slurry. Then, the negative electrode mixture slurry was applied to both surfaces of a band-shaped negative electrode current collector composed of copper foil having a thickness of 8 μm, dried, then rolled and cut into a predetermined electrode size to produce a negative electrode in which a negative electrode mixture layer is formed on both the surfaces of the negative electrode current collector. A negative electrode exposed portion where the surface of the current collector was exposed without the mixture layer was provided at the internal winding end of the negative electrode, and a negative electrode tab made of nickel was welded to the negative electrode exposed portion.

### Preparation of Non-Aqueous Electrolyte

To 100 parts by mass of a mixed solvent in which ethylene carbonate (EC) and dimethyl carbonate (DMC) were mixed at a volume ratio of 3:7 was added 5 parts by mass of vinylene carbonate (VC), lithium hexafluorophosphate (LiPF₆) was dissolved in the mixture at a concentration of 1.5 mol/liter, thereby preparing a non-aqueous electrolyte.

### Production of Test Cell

The positive electrode and the negative electrode were spirally wound via a microporous membrane separator made of polyethylene to produce a wound electrode assembly. This electrode assembly was housed in a bottomed cylindrical exterior housing can, a negative electrode tab was welded to the bottom of the bottomed cylindrical exterior housing can, and a positive electrode tab was welded to a sealing assembly. The non-aqueous electrolyte was injected into the exterior housing can, and an opening portion of the exterior housing can was sealed with the sealing assembly via a gasket to produce a cylindrical test cell.

### [Evaluation of Capacity Retention Rate]

A total of 100 test cells were prepared, and the following charge-discharge cycle was repeated 500 times for each test cell. The capacity retention rate of each test cell was determined using the equation below, and the average of the resulting 100 capacity retention rates, based on the dataset, was taken as the capacity retention rate of the test cells in Example 1-1.

Capacity retention rate=(discharge capacity at 500th cycle/discharge capacity at 1st cycle)×100

### [Charge-Discharge Cycle]

The test cell was charged under a temperature environment of 25° C. at a constant current of 0.3 C until a battery voltage reached 4.2 V, and then charged at a constant voltage of 4.2 V until a current value reached 0.01 C. Thereafter, the test cell was discharged to 2.5 V at a constant current of 0.5 C, and this charge-discharge operation was defined as one cycle.

### [Number of Peeling in Positive Electrode Mixture Layer]

After the charge-discharge cycles, the 100 test cells were disassembled to investigate the number of test cells in which the positive electrode mixture layer was peeled off. As described later, in Examples 1-2 and 1-3, as well as Comparative Examples 1-1, 2, and 3, there were test cells in which the positive electrode mixture layer was peeled off. In all such cases, the peeling occurred in the vicinity of the side parallel to the width direction of the protective member.

### Example 1-2

A test cell was produced and evaluated in the same manner as in Example 1-1. except that the temperature of the roller was changed to 130° C. in the production of the positive electrode.

### Example 1-3

A test cell was produced and evaluated in the same manner as in Example 1-1, except that the temperature of the roller was changed to 140° C. in the production of the positive electrode.

### Example 1-4

A test cell was produced and evaluated in the same manner as in Example 1-1. except that the contact time of the roller was changed to 20 seconds in the production of the positive electrode.

### Example 1-5

A test cell was produced and evaluated in the same manner as in Example 1-1, except that the contact time of the roller was changed to 30 seconds in the production of the positive electrode.

### Comparative Example 1-1

A test cell was produced and evaluated in the same manner as in Example 1-1, except that the heat treatment was not performed in the production of the positive electrode.

### Comparative Example 1-2

A test cell was produced and evaluated in the same manner as in Example 1-1, except that in the production of the positive electrode, a portion corresponding to the second positive electrode mixture layer was subjected to heat treatment in the same manner as in the first positive electrode mixture layer.

### Example 2

A test cell was produced and evaluated in the same manner as in Example 1-1, except that the number of positive electrode exposed portions was changed to three, and a positive electrode tab made of aluminum was welded to each of the three positive electrode exposed portions in the production of the positive electrode.

### Comparative Example 2

A test cell was produced and evaluated in the same manner as in Example 2, except that the heat treatment was not performed in the production of the positive electrode.

### Example 3

A test cell was produced and evaluated in the same manner as in Example 1-1, except that the number of positive electrode exposed portions was changed to one, and a positive electrode tab made of aluminum was welded to the positive electrode exposed portion in the production of the positive electrode.

### Comparative Example 3

A test cell was produced and evaluated in the same manner as in Example 3, except that the heat treatment was not performed in the production of the positive electrode.

Tables 1 and 2 show the evaluation results of the test cells according to Examples and Comparative Examples. In Table 2, the results of Example 1-1 and Comparative Example 1-1 listed in Table 1 are described again to show the relationship between the effect of suppressing the peeling of the positive electrode mixture layer and the number of positive electrode exposed portions. In the column for the number of peelings of the positive electrode mixture layer in the test cells of Examples 1-1.2, and 3, the difference in the number of peelings compared to the corresponding test cells of Comparative Examples 1-1, 2, and 3 is indicated in parentheses.

TABLE 1

| | Number of | Heat treatment | | | | | | | | Number of | |
|---|---|---|---|---|---|---|---|---|---|---|---|
| | positive | First | Second | | | | | | | peeling in | |
| | electrode | positive | positive | | | | | | | positive | |
| | exposed | electrode | electrode | Tack strength | | | Peel strength | | | electrode | Capacity |
| | portions | mixture | mixture | T1 | T2 | T1/ | P1 | P2 | P1/ | mixture | retention |
| | [pcs] | layer | layer | [N] | [N] | T2 | [N/m] | [N/m] | P2 | layer | rate [%] |
| Example 1-1 | 8 | Yes (180° | No | 370 | 310 | 1.19 | 10 | 8 | 1.25 | 0/100 | 80 |
| | | C./10 sec) | | | | | | | | | |
| Example 1-2 | 8 | Yes (130° | No | 320 | 310 | 1.03 | 9 | 8 | 1.13 | 10/100 | 84 |
| | | C./10 sec) | | | | | | | | | |
| Example 1-3 | 8 | Yes (140° | No | 340 | 310 | 1.10 | 9.5 | 8 | 1.19 | 5/100 | 82 |
| | | C./10 sec) | | | | | | | | | |
| Example 1-4 | 8 | Yes (180° | No | 440 | 310 | 1.42 | 11 | 8 | 1.38 | 0/100 | 76 |
| | | C./20 sec) | | | | | | | | | |
| Example 1-5 | 8 | Yes (180° | No | 520 | 310 | 1.68 | 13 | 8 | 1.63 | 0/100 | 72 |
| | | C./30 sec) | | | | | | | | | |
| Comparative | 8 | No | No | 310 | 310 | 1 | 8 | 8 | 1 | 50/100 | 86 |
| Example 1-1 | | | | | | | | | | | |
| Comparative | 8 | Yes (180° | Yes (180° | 370 | 370 | 1 | 10 | 10 | 1 | 0/100 | 65 |
| Example 1-2 | | C./10 sec) | C./10 sec) | | | | | | | | |

TABLE 2

| | Number of | Heat treatment | | | | | | | | Number of | |
|---|---|---|---|---|---|---|---|---|---|---|---|
| | positive | First | Second | | | | | | | peeling in | |
| | electrode | positive | positive | | | | | | | positive | |
| | exposed | electrode | electrode | Tack strength | | | Peel strength | | | electrode | Capacity |
| | portions | mixture | mixture | T1 | T2 | T1/ | P1 | P2 | P1/ | mixture | retention |
| | [pcs] | layer | layer | [N] | [N] | T2 | [N/m] | [N/m] | P2 | layer | rate [%] |
| Example 1-1 | 8 | Yes (180° | No | 370 | 310 | 1.19 | 10 | 8 | 1.25 | 0/100 | 80 |
| | | C./10 sec) | | | | | | | | (−50) | |
| Comparative | 8 | No | No | 310 | 310 | 1 | 8 | 8 | 1 | 50/100 | 86 |
| Example 1-1 | | | | | | | | | | | |
| Example 2 | 3 | Yes (180° | No | 370 | 310 | 1.19 | 10 | 8 | 1.25 | 0/100 | 77 |
| | | C./10 sec) | | | | | | | | (−20) | |
| Comparative | 3 | No | No | 310 | 310 | 1 | 8 | 8 | 1 | 20/100 | 80 |
| Example 2 | | | | | | | | | | | |
| Example 3 | 1 | Yes (180° | No | 370 | 310 | 1.19 | 10 | 8 | 1.25 | 0/100 | 75 |
| | | C./10 sec) | | | | | | | | (−10) | |
| Comparative | 1 | No | No | 310 | 310 | 1 | 8 | 8 | 1 | 10/100 | 78 |
| Example 3 | | | | | | | | | | | |

As shown in Table 1, the test cells of Examples 1-1 to 1-5 achieved a high capacity retention rate while suppressing peeling of the positive electrode mixture layer. On the other hand, the test cells of Comparative Examples 1-1 and 1-2 failed to achieve both suppression of peeling of the positive electrode mixture layer after the charge-discharge cycle and suppression of reduction in the battery capacity. Furthermore, it was found from the results shown in Table 2 that the greater the number of positive electrode exposed portions in the test cells, the more effective the suppression of peeling of the positive electrode mixture layer.

The present disclosure will be further described with the following embodiments.

### Constitution 1:

A cylindrical secondary battery, comprising:
an electrode assembly in which a positive electrode and a negative electrode are wound via a separator;
a non-aqueous electrolyte; and
a cylindrical exterior housing can housing the electrode assembly and the non-aqueous electrolyte, wherein
the positive electrode has a positive electrode current collector and a positive electrode mixture layer disposed on a surface of the positive electrode current collector,
a positive electrode exposed portion where the positive electrode current collector is exposed is disposed on a surface of the positive electrode,
the positive electrode exposed portion is in contact with only one end of opposite ends of the positive electrode in a width direction,
a positive electrode tab is connected to the positive electrode exposed portion and drawn out from one end thereof,
a protective member covers the positive electrode exposed portion, the positive electrode tab, and a portion of the positive electrode mixture layer adjacent to the positive electrode exposed portion, and
when the positive electrode mixture layer is divided into a first positive electrode mixture layer aligned with the positive electrode exposed portion in a longitudinal direction of the positive electrode and a second positive electrode mixture layer adjacent to the positive electrode exposed portion and the first positive electrode mixture layer in a width direction of the positive electrode, a tack strength T1 of the first positive electrode mixture layer and a tack strength T2 of the second positive electrode mixture layer satisfy a relationship of T1>T2.

### Constitution 2:

The cylindrical secondary battery according to Constitution 1, wherein the T1 and the T2 satisfy a relationship of 1.03≤T1/T2≤1.68.

### Constitution 3:

The cylindrical secondary battery according to Constitution 1, wherein the T1 and the T2 satisfy a relationship of 1.10≤T1/T2≤1.42.

### Constitution 4:

The cylindrical secondary battery according to any one of Constitutions 1 to 3, wherein the T1 is greater than or equal to 320 N and less than or equal to 520 N. Constitution 5:

The cylindrical secondary battery according to any one of Constitutions 1 to 4, wherein a plurality of the positive electrode exposed portions are disposed on the surface of the positive electrode.

### Constitution 6:

The cylindrical secondary battery according to any one of Constitutions 1 to 5, wherein a peel strength P1 of the first positive electrode mixture layer and a peel strength P2 of the second positive electrode mixture layer satisfy a relationship of P1>P2.

### Constitution 7:

The cylindrical secondary battery according to Constitution 6, wherein the P1 and the P2 satisfy a relationship of 1.13:5 P1/P2≤1.63.

### Constitution 8:

The cylindrical secondary battery according to Constitution 6, wherein the P1 and the P2 satisfy a relationship of 1.19:5≤P1/P2≤1.38.

### Constitution 9:

The cylindrical secondary battery according to any one of Constitutions 6 to 8, wherein the P1 is greater than or equal to 9 N/m and less than or equal to 13 N/m.

### REFERENCE SIGNS LIST

10 (Cylindrical) secondary battery, 11 Positive electrode, 12 Negative electrode, 13 Separator, 14 Electrode assembly, 15 Exterior housing can, 16 Sealing assembly, 17, 18 Insulating plate, 19 Positive electrode tab. 20 Negative electrode tab, 21 Grooved portion. 22 Filter, 23 Lower vent member, 24 Insulating member, 25 Upper vent member, 26 Cap, 26a Opening portion, 27 Gasket, 30 Positive electrode current collector, 32 Positive electrode mixture layer, 34 Positive electrode exposed portion, 36 Protective member, 38 First positive electrode mixture layer, 39 Second positive electrode mixture layer

1. A cylindrical secondary battery, comprising:
an electrode assembly in which a positive electrode and a negative electrode are wound via a separator;
a non-aqueous electrolyte; and
a cylindrical exterior housing can housing the electrode assembly and the non-aqueous electrolyte, wherein
the positive electrode has a positive electrode current collector and a positive electrode mixture layer disposed on a surface of the positive electrode current collector,
a positive electrode exposed portion where the positive electrode current collector is exposed is disposed on a surface of the positive electrode,
the positive electrode exposed portion is in contact with only one end of opposite ends of the positive electrode in a width direction,
a positive electrode tab is connected to the positive electrode exposed portion and drawn out from one end thereof,
a protective member covers the positive electrode exposed portion, the positive electrode tab, and a portion of the positive electrode mixture layer adjacent to the positive electrode exposed portion, and
when the positive electrode mixture layer is divided into a first positive electrode mixture layer aligned with the positive electrode exposed portion in a longitudinal direction of the positive electrode and a second positive electrode mixture layer adjacent to the positive electrode exposed portion and the first positive electrode mixture layer in a width direction of the positive electrode, a tack strength T1 of the first positive electrode mixture layer and a tack strength T2 of the second positive electrode mixture layer satisfy a relationship of T1>T2.

2. The cylindrical secondary battery according to claim 1, wherein the T1 and the T2 satisfy a relationship of 1.03≤T/T2≤1.68.

3. The cylindrical secondary battery according to claim 1, wherein the T1 and the T2 satisfy a relationship of 1.10≤T1/T2≤1.42.

4. The cylindrical secondary battery according to claim 1, wherein the T1 is greater than or equal to 320 N and less than or equal to 520 N.

5. The cylindrical secondary battery according to claim 1, wherein a plurality of the positive electrode exposed portions are disposed on the surface of the positive electrode.

6. The cylindrical secondary battery according to claim 1, wherein a peel strength P1 of the first positive electrode mixture layer and a peel strength P2 of the second positive electrode mixture layer satisfy a relationship of P1>P2.

7. The cylindrical secondary battery according to claim 6, wherein the P1 and the P2 satisfy a relationship of 1.13≤P1/P2≤1.63.

8. The cylindrical secondary battery according to claim 6, wherein the P1 and the P2 satisfy a relationship of 1.19≤P1/P2≤1.38.

9. The cylindrical secondary battery according to claim 6, wherein the P1 is greater than or equal to 9 N/m and less than or equal to 13 N/m.
